(19) United States
(12) Patent Application Publication
(10) Pub. No.: US 2006/0294519 A1
(43) Pub. Date: Dec. 28, 2006

(54) Virtual machine control method and program thereof

(76) Inventors: Naoya Hattori, Hachioji (JP); Toshiomi Moriki, Kunitachi (JP); Yuji Tsushima, Hachioji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/472,386

(22) Filed: Jun. 22, 2006

(30) Foreign Application Priority Data
Jun. 27, 2005 (JP) 2005-186173

(51) Int. Cl. G06F 9/455

(52) U.S. Cl. 718/1

(57) ABSTRACT

Disclosed is a virtual machine control method for switching and executing multiple programs jointly shared between at least one CPU and memory. The method is comprised of a process for setting a first memory protection table for defining a memory area accessible by a first program executed on the CPU, a process for setting a second memory protection table for defining a memory area accessible by a second program executed on the CPU, a process for detecting the start of execution of the first or the second program, a process for selecting and switching to either of a first or the second memory protection table according to the detected first or the second program, and a process for checking the first or the second memory protection table with the memory management unit for the CPU, and protecting the memory area defined in the first or the second memory protection table.

### CLAIM OF PRIORITY

The present application claims priority from Japanese application JP 2005-186173 filed on Jun. 27, 2005, the content of which is hereby incorporated by reference into this application.

### BACKGROUND OF THE INVENTION

The present invention relates to a virtual machine system, and relates to technology for protecting the memory by switching control between the virtual machine monitor and guest OS (operating system), and the guest application.

As the number of servers increases, the operating complexity increases and the operating cost becomes a problem. One technique for lowering the operating cost that is the focus of much attention is placing multiple servers under the unified control of one server. One technology for unifying servers is known as a virtual machine in which a computer is logically subdivided into optional segments. In this method for example, firmware (or middleware) such as Hypervisor subdivides the physical computer into multiple logical partitions (LPAR: Logical Partition) and, allots the computer resources (CPU, main memory, I/O) to each LPAR. Here, each OS is operated on a matching LPAR so that flexible server unification is achieved by time-sharing the CPU. As an alternative, one host OS may be operated on one server, and multiple guest OS may then be operated on that host, so that unified server operation is achieved by operating each guest OS on each server.

The virtual machine technology of the related art utilized a large-size computer such as a main frame. In recent years however, even low-end servers and personal computers are increasingly used as microprocessor capability improves.

Computers such as servers that utilize virtual machine technology, include multiple virtual machines to operate the guest (operating system), and a virtual machine monitor (hereafter called VMM) to control the virtual machines. To unify the servers via virtual machine technology, it is essential that the virtual machines be kept isolated from each other as well as from the VMM. To ensure their mutual isolation, the memory range that is accessible by the three entities made up of the application (guest application) and OS (guest OS) and VMM must be restricted. (For example, please refer to JP-A No. 318797/2001, US Patent laid-open application 0120856/2003.)

The CPU usually contains a memory management unit (hereafter abbreviated to MMU) as a device for protecting the memory. This memory management unit compares the privilege level (1) of the code being executed, with the privilege level (2) of the memory area of the access destination; and prohibits access if (2) possesses higher privileges than (1). The isolation of the virtual machines from the VMM, and among mutual virtual machines can be ensured in this way by utilizing the privilege level.

### SUMMARY OF THE INVENTION

The CPU usually contains a memory management unit (MMU) as a device for protecting the memory. The memory management unit compares the privilege level (1) of the code being executed, with the privilege level (2) of the memory area of the access destination; and prohibits access if (2) possesses higher privileges than (1). The isolation of the virtual machines from the VMM, and among mutual virtual machines is ensured by using the privilege level in this way.

One method proposed for improving microprocessor performance in recent years is to expand the preexisting 32 bit architecture (For example:

IA-32 Intel® Architecture Software Developer's Manuals http://www.intel.com/design/pentium4/manuals/index_new.htm) to 64 bit architecture (For example:

Intel® Extended Memory 64 Technology Software Developer's Guide http://www.intel.com/technology/64 bitextensions/300834.htm http://www.intel.com/technology/64 bitextensions/300835.htm)

However, using a 64 bit microprocessor architecture expanded from 32 bit architecture as in the above example of the related art causes the following problems.

1) A virtual machine operating multiple guest OS on the host OS, and operating servers for each guest OS, protects the memory by utilizing the MMU of a CPU (in this case IA-32) that safeguards access between the VMM and guest OS and guest application.

The CPU such as an IA-32 in other words includes two types of protective devices called a segment and paging that serve as devices to protect the MMU memory. The segment is a device including a four stage privilege level. In the segment, a privilege level can only be set in one consecutive memory area. Privilege levels cannot be set that span multiple segments.

The paging unit on the other hand, only protects the memory with two privilege levels. However the privilege level can be set in separate virtual memory areas units called pages. In other words, in paging, the same privilege level can be set in multiple area units even if the individual areas are not connected to each other.

In virtual machines operating multiple guest OS on the host OS, the address area of the virtual memory is divided into two areas. To provide memory protection, one memory area protected by segments (4 stage privilege level) is allotted to the guest OS and VMM; and the other memory area protected by paging (2 stage privilege level) is allotted to the guest application and host OS.

However in the EM64T of the related art whose IA-32 architecture was expanded to a 64 bit CPU (EM64T, etc.), there was the problem that specifying the virtual memory area to protect was impossible if the specifications for the segment were changed as with the EM64T above. So using a virtual machine operating multiple guest OS on the host EM64T, the only way to protect the guest and VMM was by using the paging two stage privilege level, creating the problem that the virtual machine and VMM could not be kept isolated.

2) Multiple guest OS can also be operated by one server on LPAR the same as virtual machine technology. In the related art however, the TLB (Translation Lookaside Buffer) of the CPU that ensures the logical partitions are isolated, was expanded, and a guest identifier is added to the TLB entry (for example in JP-A No. 84884/1995. This guest identifier is checked when the CPU accesses the memory and the memory is then protected. However in microprocessors such as the pre-existing IA-32, there is no corresponding TLB entry so the related art contains an inherent problem in that this method cannot be used on microprocessors such as the EM64T.

To address the above described problems, this invention aims at providing a virtual machine utilizing a microprocessor with a two stage privilege level to protect the memory area has the object of reliably protecting the memory among the guest application and guest OS and the VMM.

One aspect of this invention resides in a method for controlling a virtual machine for switching and executing multiple programs jointly shared between at least one CPU and memory, a first program executed by the CPU sets a first memory protection table for defining the accessible memory range and, a second program executed by the CPU sets a second memory protection table for defining the accessible memory range and, detects the start of the first or the second program, and selects and switches to a first or second memory protection table matching the first or second program whose start was detected, and this first or second memory protection table searches the CPU memory management unit and protects the memory area defined by the selected first or second memory protection table.

According to the aspect, the first program is a virtual machine monitor for monitoring the virtual machine. The second program is a guest program operating on the virtual machine. The virtual machine monitor itself performs the (program) detection and the switching.

According to the aspect, the first program is a guest OS operating on the virtual machine. The second program is a guest application operating on the virtual machine. The virtual machine monitor for monitoring the virtual machine performs the (program) detection and the switching.

According to the aspect, even when the virtual machine is configured to utilize a CPU that only sets a two-stage address protection mechanism (privilege level), the memory areas for the virtual machine monitor and guest OS and guest application can be reliably protected and a highly reliable virtual machine system attained, by switching to the program to execute by utilizing a first or a second memory protection table that defines two program areas on the guest side and the virtual machine monitor side.

### BRIEF DESCRIPTION OF THE DRAWINGS

Embodiments of the present invention will be described in detail based on the following figures, wherein:

FIG. 1 is a block diagram showing the physical computer 200 for operating the virtual machine system of a first embodiment of this invention;

FIG. 2 is a block diagram showing an essential section of the software and the hardware of the virtual machine system;

FIG. 3 is a diagram showing the states for switching between the memory area and the host memory protection table during guest OS operation and during guest application operation;

FIG. 4 is a graph showing the relation between the host memory protection table and the usable memory area at each specified time period;

FIG. 5 is a map of the memory area;

FIG. 6 a block diagram showing the structure of the guest memory protection table or the host memory protection table;

FIG. 7 is a block diagram showing the structure of the page table set;

FIG. 8 is a flowchart showing an example of the processing performed on the guest side and by the VMM;

FIG. 9 is a flowchart showing an example of the processing performed in S11 of FIG. 8 for forming the memory protection table;

FIG. 10 is a flowchart showing an example of the process for updating the memory protection table performed in S15 of FIG. 8;

FIG. 11 is a flowchart showing another example of the same process for updating the memory protection table performed in S15 of FIG. 8;

FIG. 12 is a flowchart showing yet another example of the same process for updating the memory protection table performed in S15 of FIG. 8;

FIG. 13 is a map showing an example of the page directory;

FIG. 14 is a map showing an example of the page table;

FIG. 15 is a drawing describing the setting of the U/S bit and the P bit on the guest page table set; and the setting of the U/S bit and the P bit on the first or second host page table set;

FIG. 16 is a map showing an example of the descriptor;

FIG. 17 is a drawing describing the relation of the DPL for the descriptor table on the guest side, to the DPL for the descriptor table on the first and second host memory protection table;

FIG. 18 is a flowchart showing an example of the process performed in S21 of FIG. 8 for deleting the first and the second host memory protection table;

FIG. 19 is a block diagram showing an essential section of hardware and software for the virtual machine system of a second embodiment; and

FIG. 20 is a drawing for showing the states for switching the host memory protective table and the memory area during VMM operation and during operation on the guest side in the second embodiment.

### DETAILED DESCRIPTION OF THE PREFERRED EMBODIMENTS

The embodiments of this invention are described next while referring to the accompanying drawings.

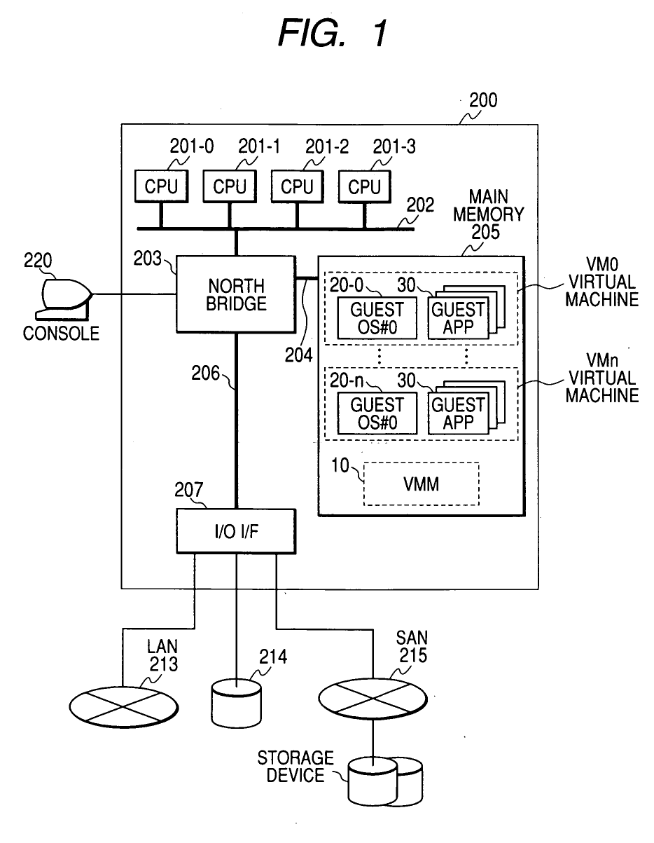

FIG. 1 is a block diagram showing the physical computer 200 for operating the virtual machine system of a first embodiment of this invention.

### 1. HARDWARE STRUCTURE

A physical computer 200 contains multiple CPU201-0 through 201-3. These CPU201 are connected via a front side bus 202 to a north bridge (or memory controller) 203. Each of the CPU201-0 through 3 includes a processing device expanded to 64 bits from the IA-32.

A memory (main memory) 205 is connected via a memory bus 204 to the north bridge 203, or is connected via a bus 206 to the I/O interface 207. The I/O interface 207 includes a network adapter connected to a LAN 213, an SCSI adapter connected to a disk device 214, etc., and a fiber channel adapter connected to a SAN (Storage Area Network) 215 etc., and is connected to each I/O device.

The CPU201-0 through 201-3 access the memory 205 via the north bridge 203, access the I/O devices via the I/O interface 207 from the north bridge 203 and perform the specified processing.

Besides controlling the north bridge 205, the north bridge 203 is also connected to a console 220 containing a graphic controller and can therefore display images. The physical computer 200 may be made up by one CPU or by two or more CPU.

A virtual machine monitor (hereafter VMM) 10 is loaded into the memory 205. Multiple guest OS #0 through #n (20-0 through 20-n) are executed on this VMM10. The guest OS #0 through #n each comprise a respective virtual machine VM0 through VMn. Multiple optional guest applications 30 are run (executed) on the guest OS #0 through #n.

### 2. SOFTWARE STRUCTURE

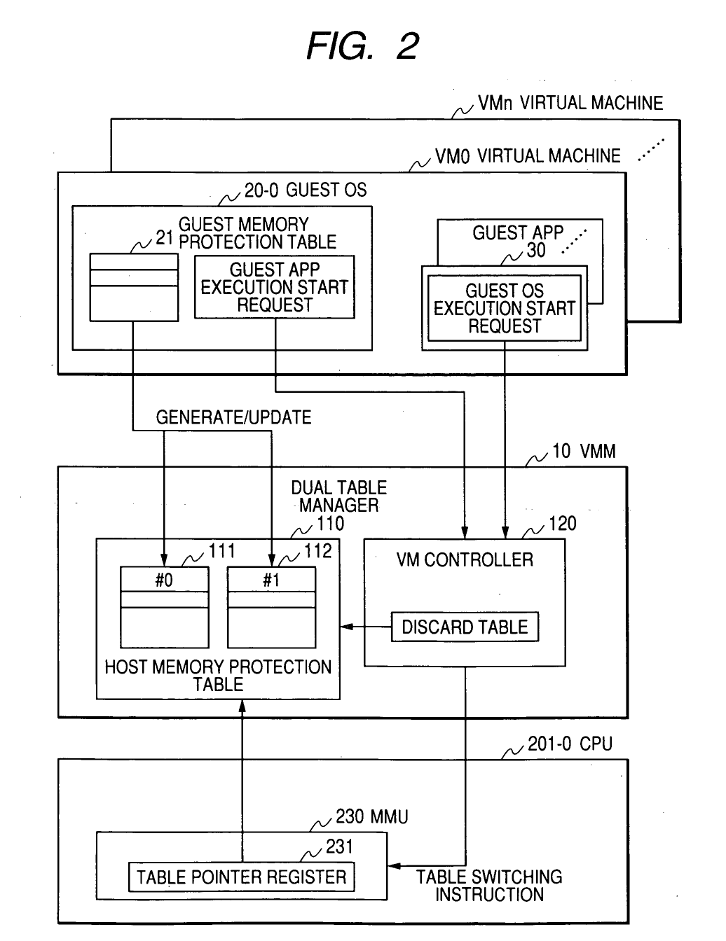

Essential sections of the software and hardware structure for running (executing) the virtual machines VM0 through VMn on the physical computer 200 are described next in detail while referring to FIG. 2.

In FIG. 2, the VMM (firmware or middleware) 10 for monitoring the multiple guest OS is operating on the physical computer 200. The VMM 10 is control software for monitoring the allotment of computing resources accessed by the multiple guest OS #0 through #n as well as the guest application 30.

The VMM 10 provides the physical computer 200 resources virtually to the guest application 30 and the guest OS #0 through #n that make up the virtual machines VM0 through n. The VMM 10 includes a virtual machine controller section (hereafter VM controller) 120 for controlling execution of the application 30 and each of the guest OS #0 through #n; and a dual table manager 110 for generating a first memory protection table (hereafter host memory protection table #0) 111 for controlling the memory area when executing the VMM 10 or the guest OS #0 through #n; and a second memory protection table (hereafter host memory protection table #1) 112 for protecting the memory area when executing the VMM 10 or the guest OS #0 through #n.

The VM controller 120 allots an area of the memory 205 for executing the virtual machines VM0 through VMn, and allots an area of the memory 205 for executing the VMM 10 itself. The VM controller 120 controls the virtual machines VM0 through n by switching the host memory protection tables #0 and #1 (formed in the dual table manager 110) according to the guest (guest OS or guest application) executed by the allotted CPU201-0 through n.

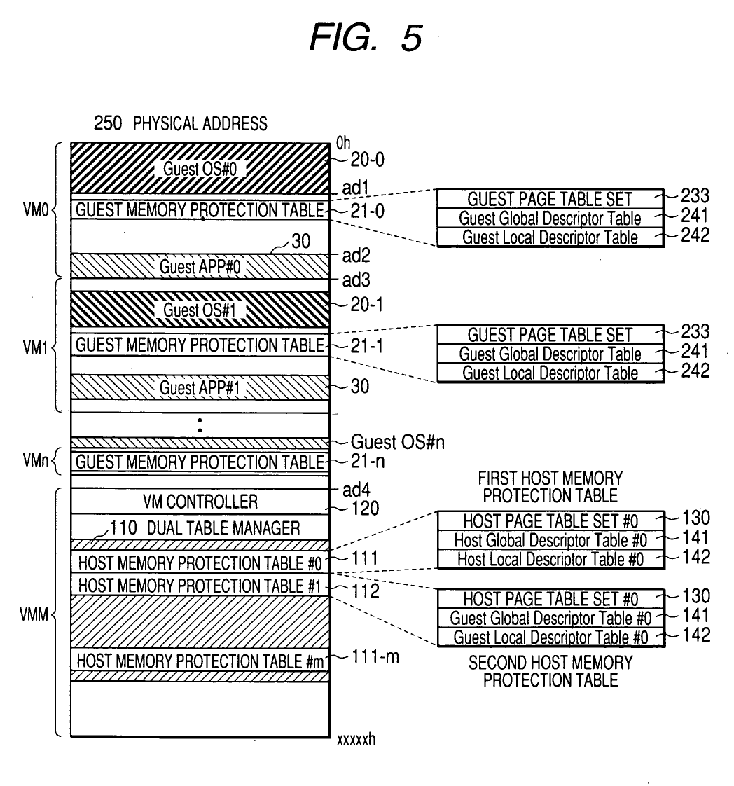

The VM controller 120 controls a specified area of the memory 205 (or a disk device 214 or a storage device on the SAN 215), as the memory area (or a physical address space) 250 as described later on using FIG. 5, and the multiple virtual machines VM0 through VMx jointly include the memory area 250. The VM controller 120 manages the memory area 250 in pages (or page units) of a specified size.

The guest OS#0 through n operate on the respective virtual machines VM0 through VMx. Within the memory area 250 allotted by the VMM 10, each OS #0 through n includes a memory area used by the guest OS and, guest memory protection tables 21-0 through n for managing the memory area used by the application 30. The VMM10 manages these guest memory protection tables 21-0 through n.

The CPU executing the VMM 10 and the virtual machines VM0 through VMn, includes a memory management unit (hereafter MMU) 230 for managing how the logical address for the memory area 250 matches the physical addresses such as for the memory 205 and the disk device 214. The MMU 230 includes a table pointer register 231 for indicating the position to execute a command on the memory area 250. When the CPU201-0 through 3 architecture is IA-32 (or EM64T), the MMU230 may contain a privilege register GDTR (global descriptor table register), or a privilege register LDTR (local descriptor table register) for controlling the privilege register CR0, CR2, CR3, CR4 or descriptor tables not shown in the drawing. The table point register 231 is equivalent to the special register CR3 in IA-32 (EM64T).

When control between the guest OS #0 and the guest application 30 is switched, the VMM 10 sends a table switching command to switch to one of the host memory protection tables #0 or #1 formed in the dual table manager 110 within the table pointer register 231.

More specifically, when a request is received to execute the guest OS, the VM controller 120 sets a pointer address in the pointer register 231 indicating the host memory protection table #0. When a request to start the guest application is received, the VM controller 120 sets a pointer address indicating the host memory protection table #1 in the table pointer register 231.

Using the host memory protection table set in the table pointer register 231, the VMM 10 then switches to a memory area protected on the memory area 250.

The VMM 10 forms two host memory protection tables #0 and #1 per the start of the guest OS or the guest application as described later on, and when the guest application 30 ends, the VMM10 discards the host memory protection tables #0 and #1 that were formed.

### 3. VMM OVERVIEW

An overview of the virtual machine system of this invention is described next. An example is described for executing the virtual machine VM0 (guest OS#0) or the guest application 30) and to simply the description, the VMM 10 assigns the virtual machine VMO to CPU 201 through 0. The memory area 250 of memory 205 is jointly shared by VMM 10 and the multiple virtual machines VM0 through VMn.

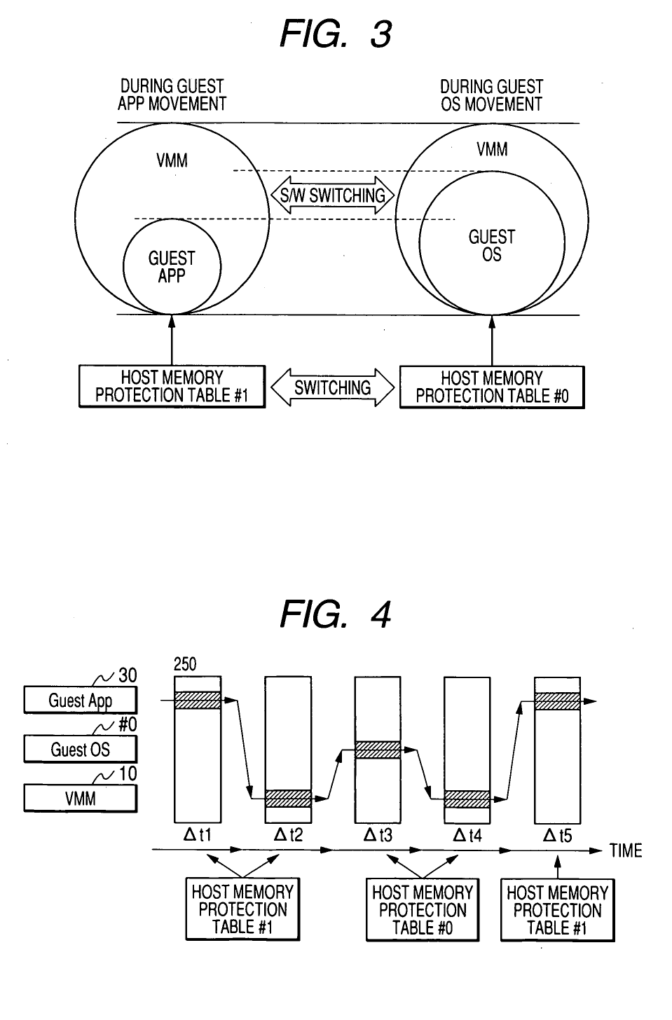

FIG. 3 is a drawing for describing the concept of the two host memory protection tables #0, #1 set in the dual table manager 110 of VMM 10.

A host memory protection table #0 serving as the first table defines the address area accessible by the guest OS #0, and the address area used by the VMM10.

A host memory protection table #1 serving as the second table defines address area accessible by the guest application 30, and the address area used by the VMM10.

When the guest #0 is running (executed) the VMM 10 selects the host memory protection table #0. The host memory protection table #0 defines the memory area that the guest #0 can access, and protects the memory area used by the VMM 10.

When the guest application 30 is executed, the VMM 10 selects the host memory protection table #1. The host memory protection table #1 defines the memory area the guest application can access, and protects the memory area used by the VMM 10.

FIG. 4 shows the relation here between the VMM10, the guest application 30 and the guest OS #0 executed on the virtual machine VM0 over time.

FIG. 4 is a graph showing the relation between the program executed by the CPU201-0 and the memory area 250 over time.

In FIG. 4, after executing the guest application 30 only for the period Δt1, the CPU201-0 then hands over control to VMM10, and executes VMM10 only for the period Δt2. Control is afterwards shifted to the guest OS #0 at period Δt3 and executed. Then control is shifted to the guest application 30 at period Δt4 and executed.

In the virtual machine system, the memory area accessible at an optional point in time is limited here. In this embodiment, any one of the VMM10, the guest OS#0 or the guest application 30 may be able to access the memory area 250.

Just one type of memory area may be made accessible when executing a particular code among the VMM10, guest OS#0 or guest application 30; and when switching the code to execute, two types of memory areas (for before and after switching) may be made accessible.

In other words, as shown in FIG. 4, the guest application 30 is able to access the specified area of the memory area 250 only at period Δt1. Next, the VMM10 is allowed to access a specified area only at period Δt2. A host memory protection table #1 functioning as page table for preserving the isolation of VMM10 and the application 30 executed on VMM10 is therefore formed as shown in FIG. 3. The area where the VMM10 can access, and the area where the guest application 30 can access are separated into two areas at periods Δt1 and Δt2 so that the isolation can be maintained.

The guest OS#0 is next executed on the VMM 10 at period Δt3 so that the guest OS #0 may be allowed to access the specified area on the memory area 250 at period Δt3. A host memory protection table #0 is therefore formed as a page table for preserving the isolation of the VMM10 and the guest OS#0 executed on the VMM10 as shown in FIG. 3. In other words, the area accessible by the VMM10 and the area accessible by the guest OS#0 may be separated into two areas to ensure isolation at period Δt3.

When next switching the program for execution on the VMM10 or in other words when switching the guest OS#0 and the guest application 30, the two host memory protection tables #0 or #1 are switched at the point in time that period Δt2 ends and the period Δt4 end in FIG. 4.

Two-stage access protection is in this way set in one host memory protection table, and by providing two host memory protection tables, the isolation of the three entities made up of the guest OS#0 and guest application 30 and the VMM10 can be ensured. In other words, if there are two privilege levels in CPU201-0 for privileges and no-privileges, then at a certain point in time, the area accessible by the program (VMM10) serving as the host, and the area accessible by the program serving as the guest (guest OS#0 or guest application 30) can be separated and protected.

### 4. VMM DETAILED DESCRIPTION

<4.1 Structure>

FIG. 5 is a drawing showing an example of the memory area 250 managed by the VMM10.

The VMM10 allots a memory area for itself on the memory area 250, and a memory area for use by the virtual machines VM0 through VMn. The VMM10 is here in a CPU201-0 through 3 set to 64 bit mode (for example, the 64 bit mode of the EM64T), and utilizes the memory area 250 as a flat address space.

As shown for example in the figure, the VMM10 allots the virtual machine VM0 to the addresses 0h through ad3, and assigns itself to the addresses ad4 through xxxxh in the memory area.

The VM controller 120 and the dual table manager 110 are assigned to the memory area used by the VMM10. The host memory protection tables #0, #1 through #m (however m□1) are generated in the dual table manager 110 when the guest OS or the guest application are executed on the virtual machines VM0 through VMn. When the guest application or the guest OS for the virtual machines VM0 through VMn then ends, the VMM10 discards the corresponding host memory protection tables #0 through #m and the guest memory protection tables 21-0 through n.

The VMM10 defines the memory area used by the guest OS#0 through n, and defines the memory area used by the guest application 30 on the memory area of the virtual machines VM0 through VMn, and sets the guest memory protection tables 21-0 through n to ensure the isolation of the two programs.

The host memory protection tables #0 through #m and the guest memory protection tables 21-0 through n, are general terms for the page table set and the descriptor table (global descriptor table, and local descriptor table).

The host memory protection tables formed in the VMM10 include a host page table set 130 and host global descriptor table 141 and the host local descriptor table 142. The guest memory protection tables 21-0 through n formed in the virtual machine VM0 include a guest page table set 233 and guest global descriptor table 241 and the guest local descriptor table 242.

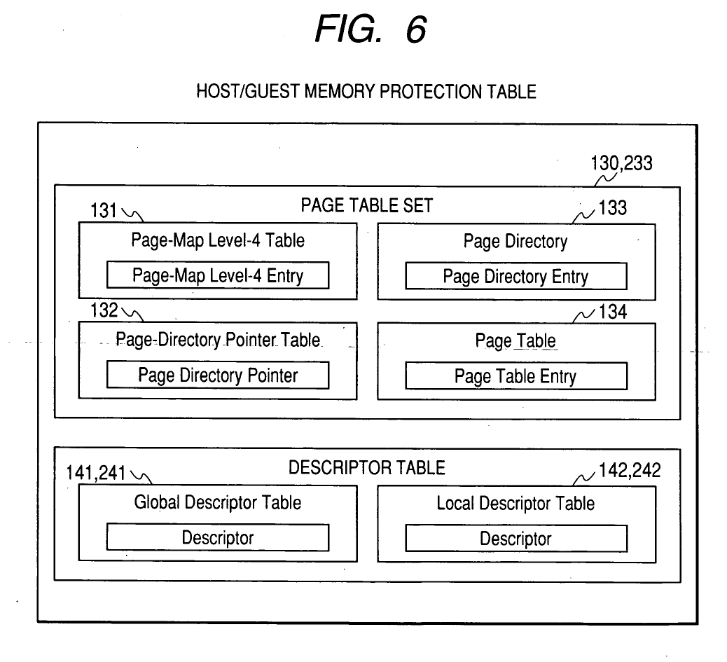

The structures of the host memory protection tables #0 through #m and the guest memory protection tables 21-0 through n are identical. The structures are shown in FIG. 6.

The page table set (host page table set 130, guest page table set 233) includes a page-map level 4-table 131 as the upper hierarchy, and a page directory pointer table 132, page directory 133, and page table 134.

The page-map level-4 (PML4) table 131 is positioned upstream of the page-directory pointer table 132 (PDP table) within the page change hierarchy for changing the physical address space and the virtual address space, and each entry indicates the PDP table 132. The page-directory pointer table 132 is positioned upstream of the page directory 133, and each entry indicates the page directory table 133. Each entry of the page directory (PDE) table 133 indicates the page table 134. Also, each entry of the page table (PTE) 134 indicates the page of the memory area 250.

The descriptor table includes a global descriptor (GDT) table 141 (241) and a local descriptor table 142 (242). One global descriptor (GDT) table 141 (241) is set in each system (VMM10, each virtual machine VM0 through n), and the local descriptor table 142 (242) are generated for each system task.

These descriptor tables contain descriptors containing information on the usage method, type, and base-address access rights of the address destination.

The VMM10 places a write-protect on the page table (hereafter guest page table) comprising the guest memory protect table.

When the guest OS or the guest application starts on the virtual machine VM in the above structure, the VMM10 forms the first host memory protection table #0, and the second host memory protection table #1 as shown in FIG. 5, forming a guest memory protection table 21-0 through n in the virtual machine VM. In other words, the VMM10 forms two memory protection tables as shown in FIG. 6. Here the relation of the address indicated by each entry of the first host memory protection table #0, to the entry indicated by the second host memory protection table #1, is set to the relation shown in FIG. 3.

As shown in FIG. 4, in the program that the CPU201-0 is executing among the guest application 30 and the guest OS#0, the VMM10 switches to the first host memory protection table #0 or second host memory protection table #1 to protect the memory area accessed by each program. The other virtual machines VM1 through VMn are all structured in this same way.

When the memory protection table of FIG. 6 is used as a host memory protection table, the page table set becomes a host page table set. When the memory protection table is used for a guest the memory protection table, the page table set becomes a guest page table set.

<4.2 Memory Protection Table Expansion>

Expanding (changing the size) the host memory protection table and the guest memory protection table is described next. The host the memory protection table and the guest memory protection table are identical structures so hereafter the general term, memory protection table is used for both of these tables.

The size of the memory protection table is variable. The EM64T in particular may have a page table set maximum size of 512 gigabytes or more. Therefore maintaining the host memory protection table at a fixed size is not practical so the size is preferably maintained according to the size of the guest memory protection table. The VMM10 therefore detects changes in the size of the guest memory protection table, and updates this host memory protection table when the size of the guest memory protection table has changed.

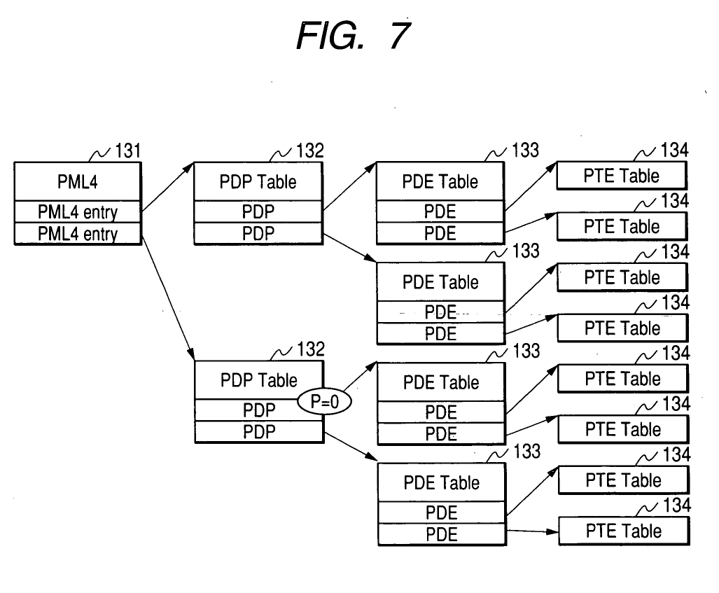

Expanding the memory protection table is described next while referring to FIG. 7. The hierarchical structure of the PDP table 132, PDE table 133 and the PTE 134 are shown in FIG. 7 based on the PML4 table 131. In the page table set for IA-32 (EM64T), the PML4 table 131 entry is the start point, and the address of the table at the tip of the arrow is set in the entry at the base of the arrow in the figure. A present bit (hereafter, P bit) is set in each entry of each of the tables 131 through 134. The address set in the entry is invalid when the P bit is zero (0). The address set in the entry is valid when the P bit is 1.

In other words, when the P bit changes from a 0 to a 1, the entry set in the lower bits of the address is valid and the page table is expanded. When the P bit changes from a 1 to a 0, the lower bits of the address become invalid and the page table is reduced. The size of the page table set can be changed by manipulating the P bit of each page table.

More specifically, the size of the page table set is changed by using the following operation.
Operation 1: Change the size of the PG (paging bit) for the privilege register CR0 (register holding the system control flag for controlling the state and operating mode of the CPU) of the CPU. Setting the PG allows paging. Clearing the PG stops the paging.
Operation 2: Change the privilege register CR3 (register storing the physical address of the base for the page directory 133).
Operation 3: Change the PAE (physical address expansion bit) of the privilege register CR4 (register for controlling the architecture expansion function types). The PAE controls the function for performing paging at 36 bits.
Operation 4: Change the PSE (page size expansion bit) of the privilege register CR4. Setting the PSE enables a 4 megabyte page table 134. Clearing the PSE restricts the page table 134 to 4 kilobytes.
Operation 5: Change the P bit in the entry of PML4 table 131.
Operation 6: Change the P bit for PDP table 132.
Operation 7: Change the P bit for PDE table 133.
Operation 8: Change the PS bit of PDE table 133. In the PS bit (or flag) operation, the PDE table entry indicates the page table 134, and the table entry indicates the 4 kilobyte page (set PS to 0), or the page directory entry directly indicates 4 megabtyes (Set the PSE and PS to 1), or the 2 megabyte page (Set PAE and PS to 1).

The operation for changing the descriptor table size is as follows.
Operation 9: Change the privilege register GDTR. The privilege register GDTR contains the linear address for the GDT base. Change this linear address.
Operation 10: Change the privilege register LDTR. The privilege register LDTR contains the linear address for the LTD base. Change this linear address.

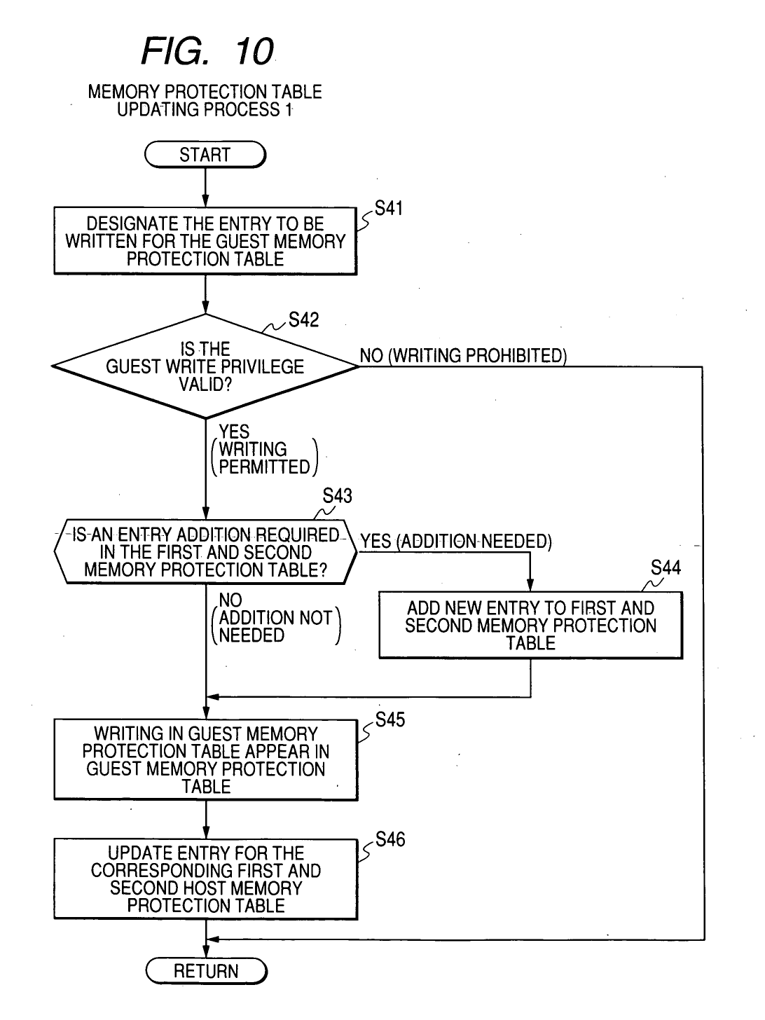

The case where the guest OS or guest application performed the above operations 5 through 8 is described later using FIG. 10.

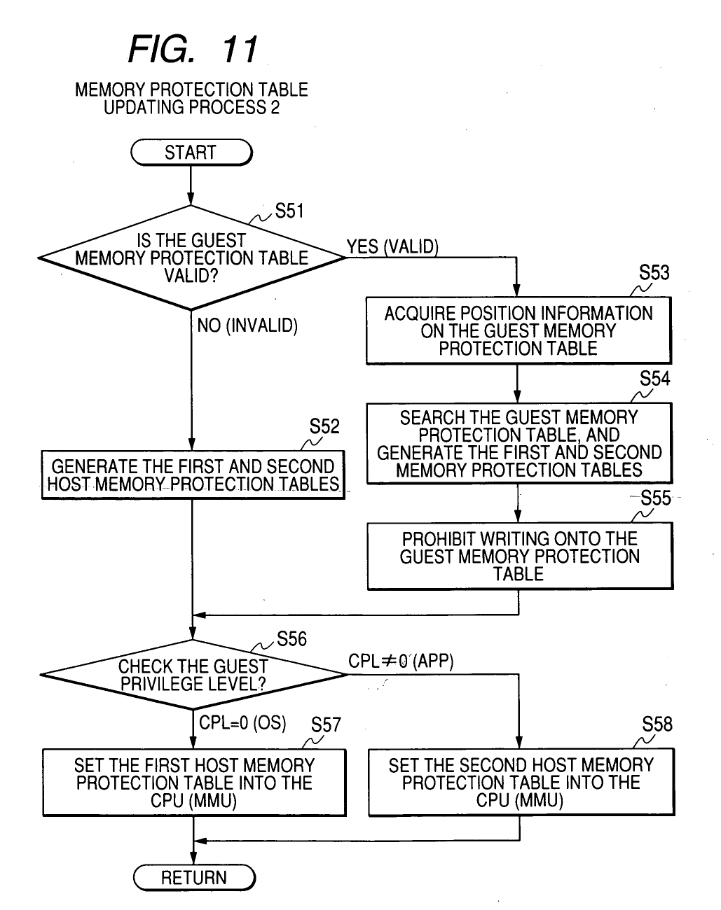

The case where the guest OS or guest application performed the above operation 1 is described later using FIG. 11.

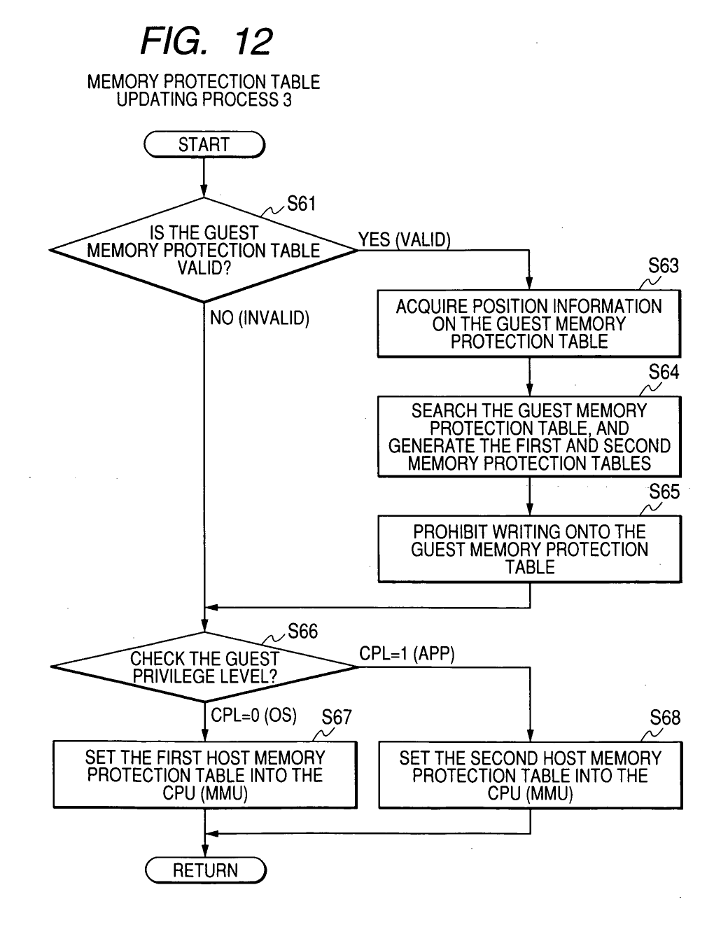

The case where the guest OS or guest application performed the above operations 2 through 4, 9, and 10 is described later using FIG. 12.

<4.3 Process Overview>

An example of the process performed by the VMM10 and the virtual VMO (guest OS#0, guest application 30) functioning as the guest is described below while referring to the flowchart.

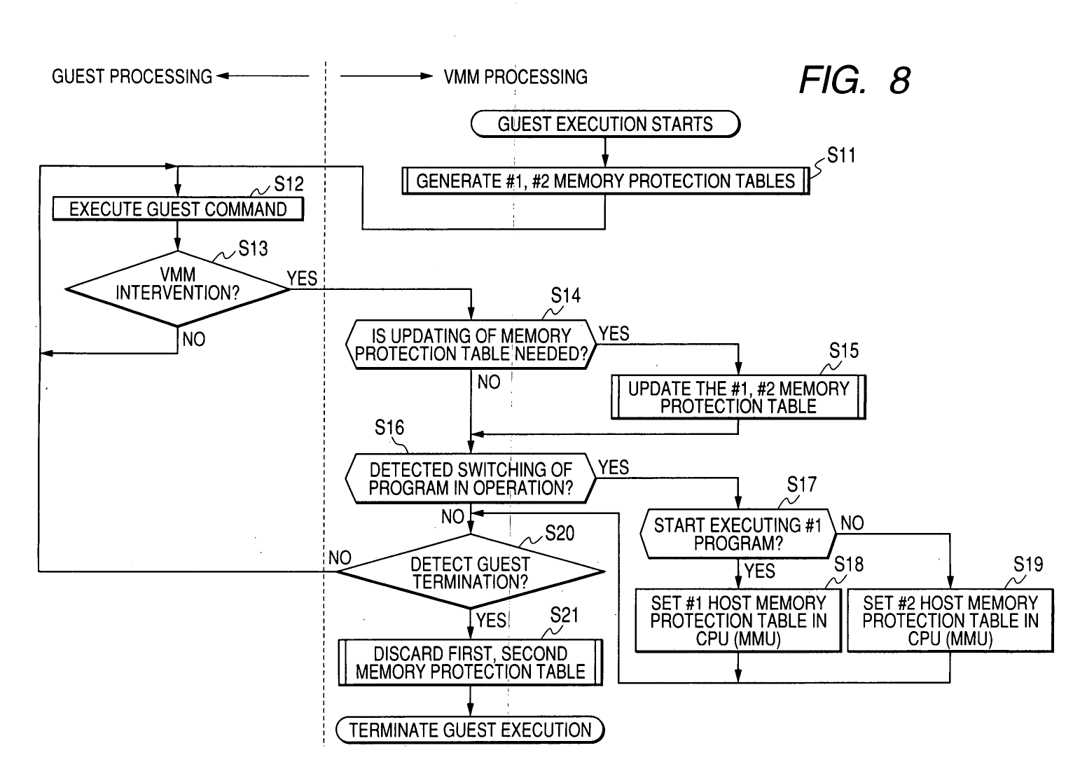

FIG. 8 is a flowchart showing the overall process when executing the guest OS#0 or the guest application 30 on the virtual machine VM0. The right side of the dashed line in the figure is the processing by the VMM10. The process on the left side of the dashed line is performed by the guest side (guest OS#0 or guest application 30).

In S11, when the VMM10 receives the application 30 execution start request from the guest OS#0, or receives a guest OS#0 execution start request from the guest application 30, then as shown in FIG. 5, the host memory protection tables #0, #1 serving as the first or the second memory protection tables for the program (guest OS#0 or guest application 30) executed on the guest side, are formed in the dual table manager 110 of VMM10 based on the guest memory protection table 21-0.

The VMM10 then writes the address of the first host memory protection table #0 in the table pointer register 231 of CPU201-0, and control then shifts to the VMM10. The VMM10 then writes the addresses of the first or second host memory protection table #0, #1 addresses into the table pointer register 231 according to the program to execute and hands over control to the guest side. In other words, to execute the guest OS#0, the VMM10 sets the host memory protection table #0 address into the table pointer register 231 of the CPU201-0; and to execute the guest application 30, sets the host memory protection table #1 address into the table pointer register 231 of the CPU201-0.

The virtual machine VM0 executes the guest (guest OS#0 or guest application 30) in S12, and decides whether or not an event has occurred requiring the intervention of the VMM10 on the guest side in S13. In other words, the process proceeds to S14 and control is returned to the VMM10 if there is an event such as a break-in (interrupt) or exception, or termination of the guest OS#0 or guest application 30 that requires the intervention of the VMM10. If intervention by the VMM10 is not needed then the process returns to S12 and the guest side processing is executed.

The above steps S12, S13 are repeated the same as above when executing the guest OS#0 on the virtual machine VM0.

In S14, the VMM10 detects if the host memory protection table #0 or #1 must be updated. In this detection process, a write-protect has been implemented, so when the guest OS #0 or the guest application 30 attempts to write on the guest memory protection table 21-0, an exception event occurs. When this exception event is detected, the VMM10 decides whether updating the memory protection table is required and the operation proceeds to S15. The process also proceeds to S15 in the same way, when the guest OS#0 has operated the privilege register.

In S15, the request from the guest application 30 or the guest OS#0 to write in the guest page table (134) is reflected and written into the VMM10 host memory protection table #0 or #1. The virtual machine VM0 guest memory protection table 21-0 is updated in the same way.

The VMM10 next detects in S16 whether the program operating on the virtual machine VM0 was switched. In other words, if the guest application 30 was switched to the guest OS#0, or the guest OS#0 was switched to the guest application 30, then the VMM10 decides a switch was made and the operation proceeds to S17.

In S17, a decision is made on whether either of the first program (here, the guest OS#0) or second program (here, the guest application 30) was switched. If a switch was made to the first program then the operation proceeds to S18, and the VMM10 sets the address of the host memory protection table #0 into the table pointer register 231 of CPU201-0. If a switch was made to the second program, then the operation proceeds to S19, and the VMM10 sets the address of the host memory protection table #1 into the table pointer register 231 of the CPU201-0.

The host memory protection tables #0, #1 indicating the memory area to protect are therefore switched in S18, S19, according to the program executed on the virtual memory VM0.

In S20, the VMM10 next decides whether or not the termination of the guest application 30 or the guest OS#0 was detected. When the guest side was terminated, the VMM10 discards the host memory protection tables #0 and #1, and terminates the program on the guest side.

When the VMM10 detects the start of the guest side program (guest OS#0 or guest application 30), it forms a first or second host memory protection table #0, #1. The first or second host memory protection table then protects the memory area used by the VMM10, and the memory area used by the guest side (virtual machine VM0 side) program.

Also, when the program executed on the guest side is switched, the VMM10 switches to the first or second host memory protection table corresponding to the program that was switched to, in order to reliably protect the each memory area of the VMM10 and guest side according to the program the CPU201-0 is executing.

<4.4 Memory Protection Table Forming Process>

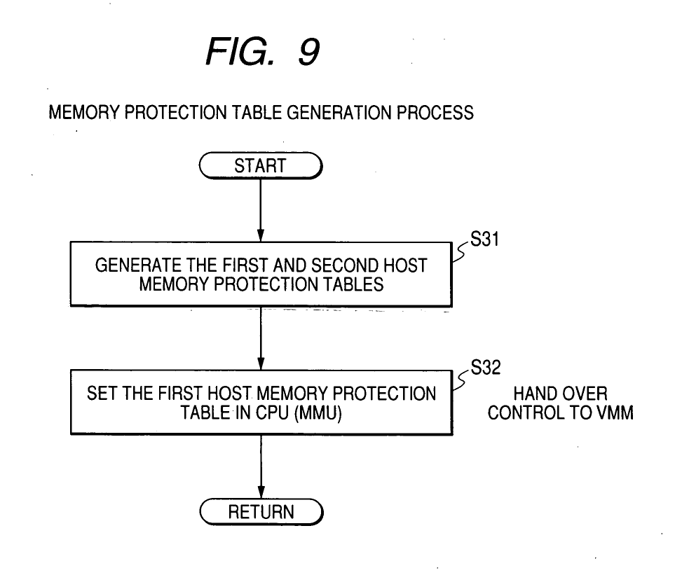

The process performed in S11 of FIG. 8 for forming the memory protection table is described next while referring to the flowchart in FIG. 9.

The operation in S31 acquires a memory area according to the program started on the guest side (guest OS#0 or guest application 30) from the virtual machine VM0 as shown in FIG. 5. The guest OS#0 serving as the first program, then forms a first host memory protection table #0, and sets the memory range for protecting the guest OS#0 and the VMM10. Also the guest application 30 serving as the second program, then forms a second host memory protection table #1, and sets the memory range for protecting the guest application 30 and the VMM10.

In S32, the VMM10 writes the address of the first host memory protection table #0 into the table pointer register 231 of CPU2-1-0 and then processing ends.

The above process forms two host memory protection tables #0 and #1 in the dual table manager 110 when the guest OS#0 or guest application 30 starts.

<4.5.1 Memory Protection Table Update Process 1>

The memory protection table update process performed in S15 of FIG. 8 is described next while referring to the flowchart in FIG. 10. FIG. 10 shows the processing when the guest OS or guest application has performed the above operations 5 through 8.

In S14 of FIG. 8, when the guest memory protection table 21-0 was written, the operation proceeds to S15 and the subroutine of FIG. 10 is executed.

In S41, the VMM10 acquires the exception that occurred in the virtual machine VM0, and the VMM10 identifies the entry of the guest memory protection table 21-0 that was written on by the guest OS.

In S42, the VMM10 next decides if the writing on the guest page table set of virtual machine VM0 is valid or not. If an exception occurred in the writing by the guest then that writing is judged invalid and this subroutine terminates. If no exception occurred then the writing is judged valid and the operation proceeds to S43.

If the above writing by the guest onto the guest page table set was invalid, then in the case of the IA-32, a typical protection exception (#GP), or a stack fault event (#SS), or an alignment exception (#AC), or page fault exception (#PF) has occurred. The above exceptions are as described in the IA-32 Intel Architecture Software Developer's Manual Volume 3: System Programming Guide Intel Extended Memory 64 Technology Software Developer's Guide Volume I of 2 (ftp://download.intel.co.jp/jp/developer/jpdoc/ia32_arh_dev_man_vol3_i.pdf).

In S43 a decision is made on whether an additional entry to the first and second host memory protection table is needed by detecting whether or not the guest memory protection table 21-0 was expanded. When the VMM10 detects expansion of the guest memory protection table, the operation proceeds to S44, and when an additional entry is not needed the operation proceeds to S45.

Expansion of the guest memory protection table is detected when any of the following conditions are satisfied.
Condition 1: The guest (guest OS or the guest application) is in 64 bit mode and the P bit of the PML4 table 131 entry has changed from 0 to 1.
Condition 2: The guest is CR4. PAE=1 and CR0. PG=1 when the P bit of the PDP has changed from 0 to 1. Here, the CR4. PAE signifies the PAE bit of the privilege register CR4, and CR0. PG signifies the PG bit of the privilege register CR0.
Condition 3: The guest setting for format XX is (!CR4. PSE| !PDE. PS) when & PDE. P has changed from 0→1. Here, CR4. PSE signifies the PSE bit for the privilege register CR4; and PDE. PS is the PS bit of the PDE table 133, and PDE. P is the P bit for PDE table 133.

The condition for 64 bit mode is established when IA32EFER. LME=1&&CR4. PAE=1&&CR0. PG=1&&CS. L=1. Here, IA32EFER. LME signifies the IA-32e mode enable (LME) bit for the expansion function enable register (IA32_EFER).

In S44, the VMM10 next adds a new entry to the first and second host memory protection tables #0, #1 corresponding to the guest memory protection table.

In S45, the VMM10 shows the writing in the guest memory protection table of the guest OS or the guest application, in the guest memory protection table. In other words, a write-protect was placed on the guest memory protection table so when the guest memory protection table is written on the guest side, only an exception event occurs, and the actual writing has not been completed. The VMM10 therefore updates the guest memory protection table according to the request from the guest side.

Then in S46, the VMM10 updates the contents written in S45, into the entry corresponding to the first and second host memory protection table #0 and #1. When the guest memory protection table has been expanded, the VMM10 in this way updates the contents of the host memory protection table #0 and #1 and makes the corresponding entries in the guest memory protection table and host memory protection table match each other.

<4.5.2 Memory Protection Table Update Process 2>

Another memory protection table update process performed in S15 of FIG. 8 is described next while referring to the flowchart in FIG. 11. FIG. 11 shows the processing when operation 1 (operation changing the PG bit of the privilege register CR0) was performed by the guest OS or the guest application.

In S51 first of all, the VMM10 checks the PG bit of CPU201-0, and then decides whether the guest memory protection table is valid or invalid from whether the paging is valid or invalid. During the guest OS bootup, the PG bit of the privilege register CR0 is off; and during application startup, it changes from off to on. An exception event occurs at this time so the VMM10 captures this exception and if the paging is valid (set) the operation proceeds to S53, and if invalid (clear) proceeds to S52.

In S52, the VMM10 checks the guest memory protection table and forms the first and second host memory protection tables #0, #1 the same as in FIG. 9.

In S53 however, with a valid guest memory protection table, the changed entry position information is acquired from the page directory entry (PDE) table 133 of the guest memory protection table.

In S54, the VMM10 checks all the guest memory protection tables, and forms the first and second host memory protection tables #0, #1.

In S55, the VMM10 sets the guest memory protection table to write-protect, and from then onwards when the guest side writes onto the guest memory protection table, the processing is set to perform as described in 4.5.1 when an exception event occurs.

In S56, the privilege level on the guest side that caused the exception event to start this subroutine, is compared with the specified value (0); and either the host memory protection table #0 for protecting the VMM10 and the guest OS, or the host memory protection table #1 for protecting the VMM10 and the guest application is selected. In other words, if the privilege level (CPL: CURRENT PRIVILEGE LEVEL is 0 then the guest OS is identified, and if the privilege level is not 0 then the guest application is identified.

In S57, at a privilege level of 0, an address showing the first host memory protection table is set in the table pointer register 231 of CPU201-0 so that the first host memory protection table #0 will be used.

In S58 with a no-privilege level 0, an address showing the second host memory protection table is set in the table pointer register 231 of CPU201-0 so that the second host memory protection table #1 will be used.

The above described processing forms the host memory protection tables #0, #1 corresponding to the guest memory protection table, when an exception event occurred due to operation 1 on the guest side.

<4.5.3 Memory Protection Table Update Process 3>

Another memory protection table update process performed in S15 of FIG. 8 is described next while referring to the flowchart in FIG. 12. FIG. 12 shows the processing when the above operations 2 through 4, 9, 10 (operation changing the privilege register CR3, 4, GDTR, LDTR) was performed by the guest OS or the guest application.

This subroutine is performed when the physical address for the base of page directory 133 of privilege register CR3, was rewritten.

In S61 first of all, a decision is made whether the guest memory protection table is valid or not, the same as in S51 of FIG. 11.

If the guest memory protection table is invalid, then there is no need to update the host memory protection table so the operation proceeds to S66.

In S63 where the paging is valid, newly added entry position information is acquired from the guest memory protection table.

In S64, the VM10 checks the memory protection table for newly added entries, and the first and second host memory protection tables #0, #1 are formed.

In S65, the VMM10 sets the guest memory protection table to write-protect, and from then onwards when the guest side writes onto the guest memory protection table, the processing is set to perform as described in 4.5.1 when an exception event occurs.

In S65, the privilege level on the guest side that caused the exception event to start this subroutine, is compared with the specified value (0); and either the host memory protection table #0 for protecting the VMM10 and the guest OS, or the host memory protection table #1 for protecting the VMM10 and the guest application is selected; and in S67 with a privilege level of 0, an address showing the first host memory protection level is set in the table pointer register 231 of the CPU201-0 so that the first host memory protection table #0 will be used. In S68 where the privilege level is not 0, an address showing the second host memory protection table is set in the table pointer register 231 of the CPU201-0 so that the second host memory protection table will be used.

The above described processing updates (generates) the host memory protection tables #0, #1 corresponding to the guest memory protection tables, when the guest side changed the privilege register address (operations 2 through 4, 9, 10).

<4.6 Setting the First and Second Host Memory Protection Tables>

The process for updating the first and second guest memory protection tables #0, #1 shown in S15 of FIG. 8 and in 1 through 3 of 4.5. is described next.

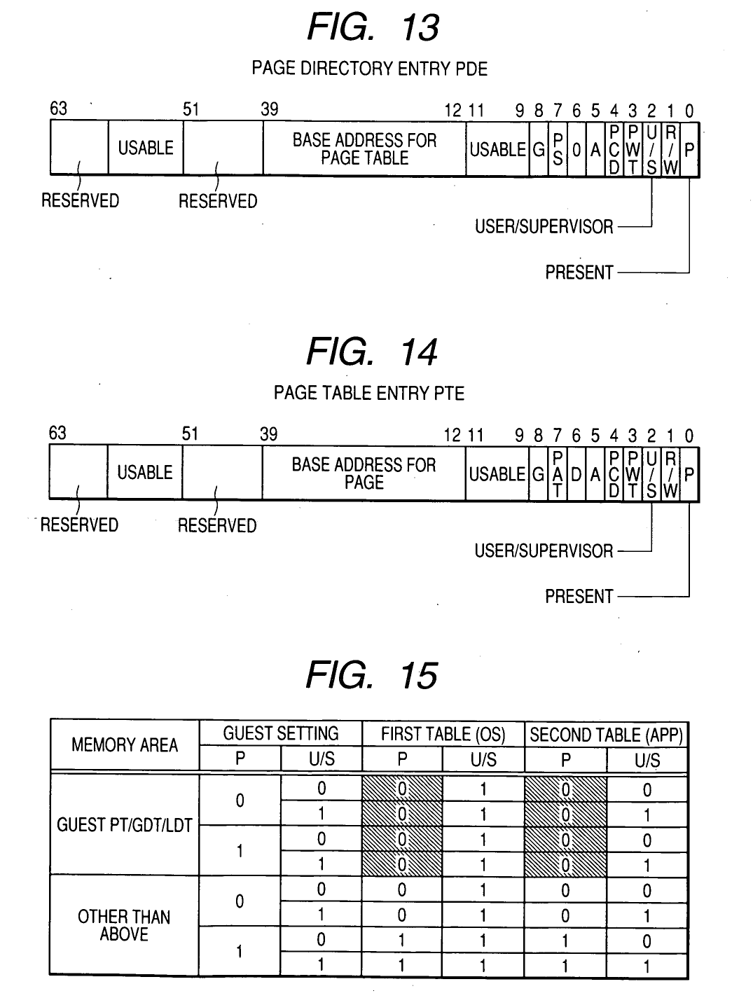

FIG. 13 shows the entries in the page directory (PDE) table 133. FIG. 14 shows the entries in the page table (PTE) 134. Each entry contains a P bit showing the entry (directory) is valid/invalid; and a U/S bit showing whether the access rights (privilege) is for the user or the supervisor. In the P bit, a 1 indicates valid, and a 0 indicates invalid. In the U/S bit, indicates access privileges with a 0 for the privilege program, and a 1 for the no-privilege program. Though not shown in the figure, the PML4 table 131 and the PDP table 132 both contain a P bit and a U/S bit in the same way.

In this embodiment, the page table set for the first host memory protection table #0 and the second host memory protection table #1 protect each of the host memory protection tables by manipulating the P bit and U/S bits in each entry. In other words, the page table set protects the memory areas of the VMM10, guest OS, and the guest application.

The P bit and the U/S bit for the guest memory protection table (page table set, descriptor table (global descriptor table GDT, local descriptor table LDT)) are set as shown in FIG. 15 to provide protection.

FIG. 15 shows the P bit and U/S bit settings on the guest side for the guest memory protection table 21-0; and shows the P bit and U/S bit settings for the first host memory protection table #0 and second host memory protection table #1 managed by the VMM10.

On the guest side (guest OS#0 or guest application 30) there a four setting combination via the guest page table set as well as setting a 0 or 1 in the U/S bit, or a 0 or 1 in the P bit of GDT and LDT. The VMM10 on the other hand, sets all P bits in the first and second host memory protection tables #0, #1 in guest memory protection table 21-0 area to zero (0), regardless of whether the P bit is a 0 or 1 on the guest side. In other words, the VMM10 sets no entries (or invalidates) in each of the guest memory protection tables, as shown by the slanted lines in the figure.

Here, the area in the first host memory protection table #0 where the P bit is “0”, is a range that only the VMM10 is allowed to access; and an area where the P bit is “1” is an area only the VMM10 and guest OS#0 are allowed to access. In the same way in the second host memory protection table #1, an area where the P bit is “0” is an area only the VMM10 can access; and an area where the P bit is “1”, is an area only the VMM10 and guest application 30 are allowed to access.

When the VM110 sets the page table set P bit in the first memory host protection table 0, this 0 in the P bit will always cause an event exception to occur when the guest OS#0 accesses the guest memory protection memory table 21-0. The VMM10 then detects access to an area for protection from the host side, and the guest OS#0 and VMM10 can then be protected. In the first host memory protection table #0, a guest OS#0 whose U/S bit is set to 1 is a no-privilege (area).

In areas other than the guest memory protection memory table 21-0 (memory areas not shown within the drawing), the VMM10 sets the first host memory protection table #0 so that the guest OS#0 is always a no-privilege area for the VMM10. In other words, the VMM10 sets the U/S bit on the first host memory protection table #0 to 1, even if the U/S bit on the guest side is 0 (privilege). The first host memory protection table #0 that protects the memory areas for both the VMM10 and guest OS#0 in this way always handles access from the guest OS#0 as no-privilege access.

In the second host memory protection table #1 that protects the memory areas for both the VMM10 and the guest application 30, areas other than the guest memory protection table 21-0 (memory areas not shown within the drawing) conform to guest side settings in the both the P bit and U/S bit.

The descriptor table (GDT, LDT) settings for the first and second host memory protection tables #1, #2 are described next.

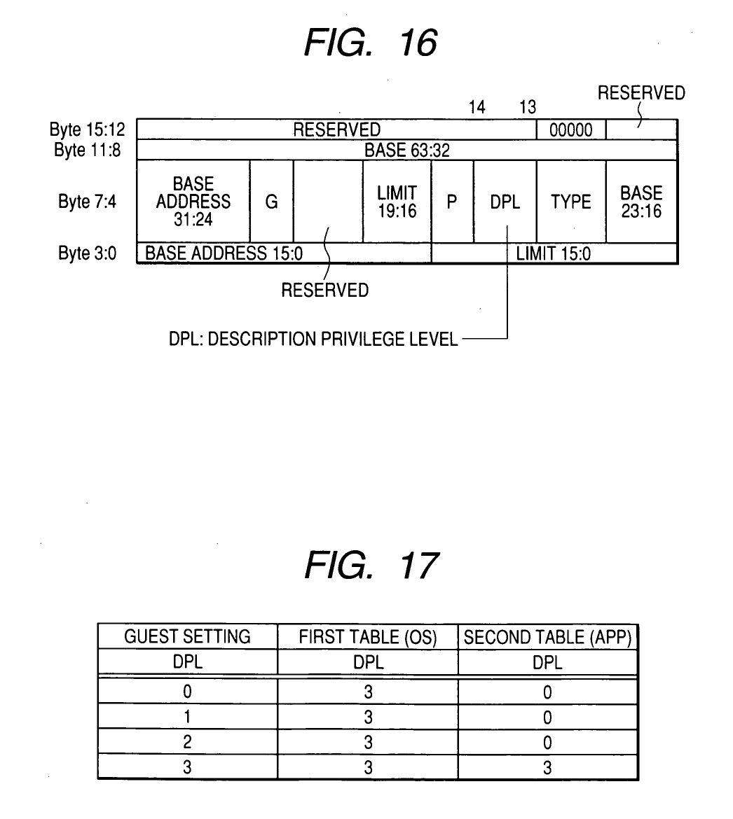

FIG. 16 is an LDT descriptor as an example of a typical descriptor. This LDT descriptor contains a two bit DPL (Description Privilege Level) showing the privilege (level) of the descriptor. The DPL can set four stages of privilege levels from 0 through 3. However, for practicality this embodiment employs the two privilege levels 0 and 3.

FIG. 17 shows the guest side settings in the descriptor table, and shows the first and second host memory protection tables #0, #1 settings.

First of all, when the guest side has set the DPL to 0, then the DPL is set to 3 in the first memory host protection table #0, which is the lowest privilege level, and the guest Os#0 privilege level is lowered, protecting the area used by the VMM10. The first memory host protection table #0 is also set to 3 if the guest side setting on the DPL is from 1 through 3.

The second host memory protection table #1 holds the settings for application 30 so the DPL setting for the second host memory protection table is set to 3 only when the setting on the guest side is 3. Also the memory area used by the VMM10 and application 30 is protected at DPL=0.

As described above, by setting the P bit of the page table set for the first and second host memory protection table #0, #1 in this embodiment to 0, prevents the guest side (guest OS#0, guest application 30) from the accessing the VMM10 area. Moreover by always handling the guest OS #0 as a no-privilege program, the VMM10 area can be protected with a high privilege level or access rights.

<4.7 Memory Protection Table: Deletion Process>

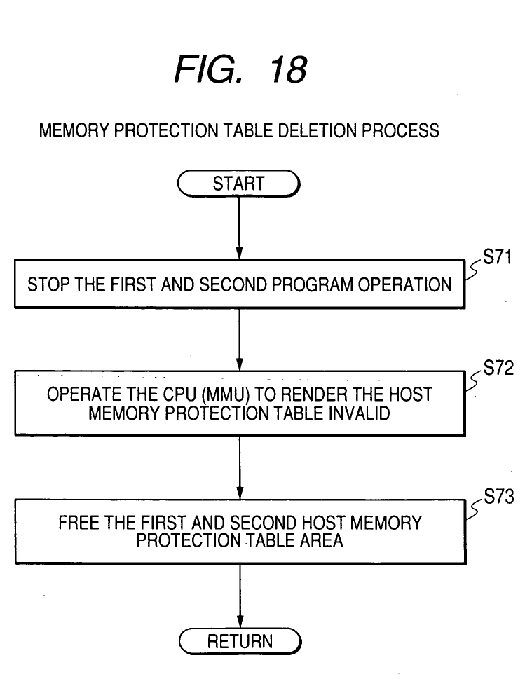

FIG. 18 is a flowchart showing an example of the process in S21 of FIG. 8 for deleting the first and second host memory protection table #0, #1.

First of all, in S71 the VMM10 stops the guest OS#0 (first program) and guest application 30 (second program) operation on the virtual machine VM0.

Next, in S72 the addresses in the first host memory protection table #0 and the second host memory protection table #1 set in the MMU230 table pointer register 231 of the CPU201-0 are rendered invalid.

The memory areas of the first and second host memory protection tables #0, #1 are then released, and the two host memory protection tables are deleted and the process terminates.

### 5. CONCLUSION

In this embodiment as described above, by switching the host memory protection tables defining memory areas for the two programs for the guest side and VM10 side according to the guest; the memory areas for the VMM10 and guest OS#0 and the guest application 30 can be securely protected to provide a highly reliable virtual machine system, even when utilizing a virtual machine utilizing a CPU that can only set a two stage address protection device (privilege level) for example in a 32 bit architecture CPU such as the preexisting IA-32 expanded to a EM64T.

The above embodiment employed an example of an IA-32 expanded to an EM64T serving as the 64 bit PU. However, the VMM10 and guest OS#0 and the guest application 30 can be accurately protected in the same way using a CPU architecture such as the AMD64 (AMD Corp.).

### Second Embodiment

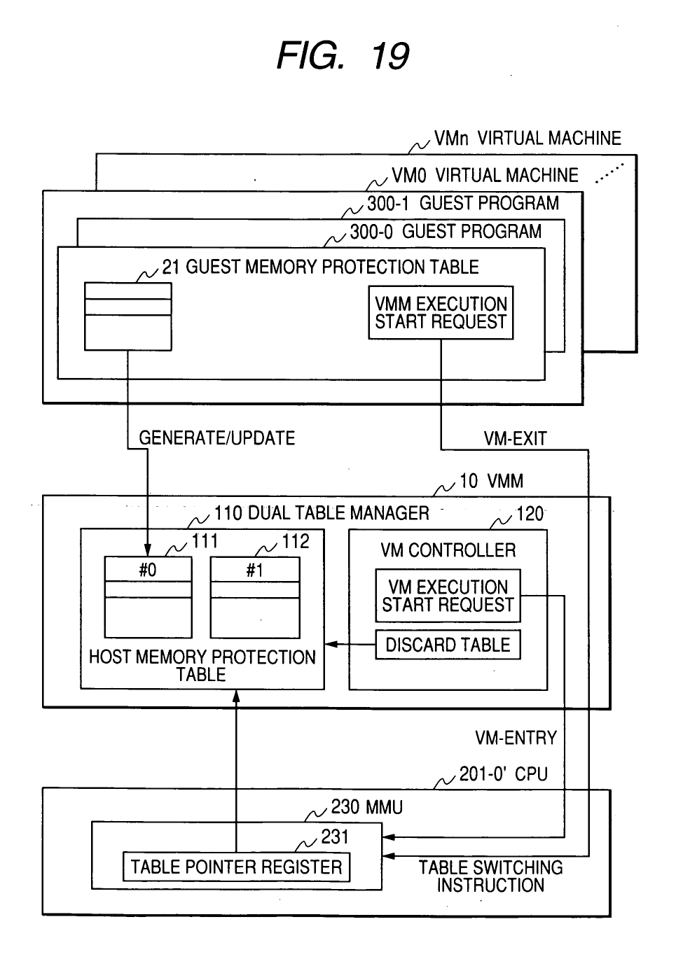

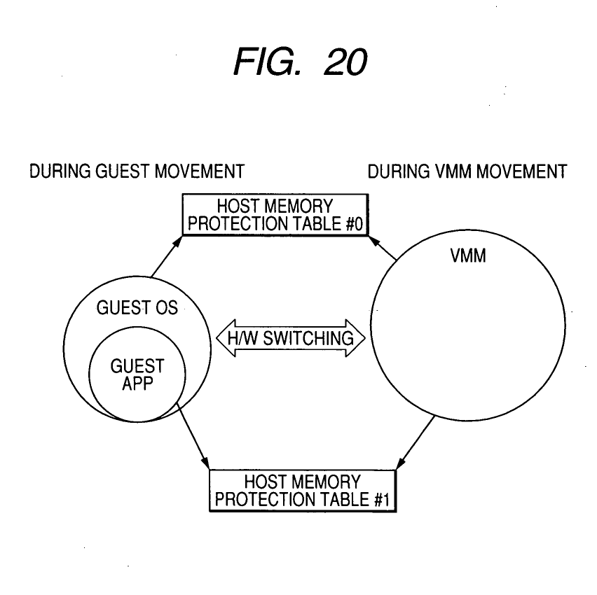

FIG. 19 and FIG. 20 show a second embodiment. In this embodiment a CPU201-0′ through 3 containing virtual machine technology is substituted for the CPU201-0 through 3 of the first embodiment, however all other elements of the structure are identical to the first embodiment. Structural elements identical to the first embodiment are assigned the same reference numerals (drawing numbers) and redundant descriptions are omitted.

The CPU201-0′ through 3 includes a mechanism using hardware to perform the switching between the virtual machines VM0 through VMn (guest OS or guest application) and the VMM10. This device utilizes hardware to switch the memory protection table and the privilege level of the guest program (guest OS or the guest application) and the VM10. In the VMM10 of the related art the software was switched by software, however the processing overhead from switching the program can in this way be performed at high speed via hardware processing. This method is known for example in, “Intel Virtualization Technology Specification for the IA-32 Intel Architecture” (ftp://download.intel.com/technology/computing/vptech/C97063-002.pdf), etc.

FIG. 20 is a block diagram showing an essential section of the hardware and software structure for the virtual machine VM0 through VMn on the physical computer 200. The guest OS or the guest application executed on the virtual machine VM on the guest side are hereafter both treated as the guest program.

Multiple virtual machines VM0 through VMn are operated on the VMM10 the same as in the first embodiment. The virtual machine VM0 here is made up of multiple guest programs. The guest program 300-0 for example is the guest OS, and the guest program 300-1 is the guest application 30 on the guest OS#0. The virtual machine VM0 made up of a CPU201-0′ and two guest programs 300-0 (guest OS#0) and 300-1 (guest application 30) is described next.

When executing the guest programs 300-0 and 300-1, the VMM10 forms host memory protection tables #0, #1 to execute the dual table manager 110, the same as in the first embodiment.

In the initialization processing, the VMM10 registers the host memory protection table #0 corresponding to the guest program 300-0, and the host memory protection table #1 corresponding to the VM10. The VM controller 120 then sends a VM-ENTRY command (VMLAUNCH command, etc.) to the CPU201-0′ when executing the guest program 300-0. To switch control from the VMM10 to the guest program, this VM-ENTRY command lower the privilege level setting and at the same time sets a pre-designated table in the table pointer register 231 of the MMU230. In this embodiment, the VM-ENTRY command sets the host memory protection table #0.

When the VM-ENTRY command from the VMM10 is received, the CPU201-0′ incorporating virtual machine technology switches control to the guest program 300-0 by switching the privilege level and the memory protection table to the guest side. The guest program 300-0 is the guest OS#0. As shown in FIG. 20, the host memory protection table #0 protects the VMM10 memory area and the guest OS#0 memory area the same as in the first embodiment.

The CPU201-0′ shifts the control from the guest side to the VMM10, when it receives the VM-EXIT command from the guest side. In order to shift control from the guest program to the VMM10, the VM-EXIT command sets a high privilege level and at the same time sets a pre-designated table in the table pointer register 231 of the MMU230. In the present embodiment, when the CPU201-0′ receives a VM-EXIT command from the guest program, it switches the privilege level to the VMM10, and then switches control to the VMM10 after switching the memory protection table to the VMM side.

The VMM10 next sends a VM-ENTRY command to the CPU201-0′ the same as above, when executing the guest program 300-1 (equivalent to guest application 30).

The VM-ENTRY command changes the host memory protection table from #0 to #1. As shown in FIG. 20, the CPU201-0′ of MMU230 protects the VMM10 memory area and the guest OS#0 memory area, the same as in the first embodiment.

Even when the CPU201-0′ was employed to assist in switching the VMM10 and virtual machine VM0 by hardware in this way, the VMM10 registers the CPU operation that accompanies switching the VMM10 itself or the guest program in the CPU, and by switching the first or second host memory protection tables in this way the same as in the first embodiment, ensures the isolation of the guest OS#0, the guest application 30 and the VMM10, to improve the reliability of the virtual machine.

The host memory protection tables may be formed on the memory area 250 for each guest OS and guest application the same as in the first embodiment, and may be detected after execution is complete.

The CPU201-0′ incorporating the virtual machine technology may be 64 bit architecture the same as the first embodiment.

In a control method for a virtual machine according to the application concerned, the switching process comprises:

a process for comparing the specified values for privilege levels of a first program and a second program, and

a process for selecting and switching the first program when the privilege level is high, and selecting and switching the second program when the privilege level is low.

In a program for a virtual machine according to the application concerned, the switching sequence comprises:

a sequence to compare the specified privilege level values for the first and program and second program, and

a sequence to select and switch the first program when the privilege level is high, and select and switch the second program when the privilege level is low.

In a control method for a virtual machine according to the application concerned, multiple guest applications are executed on the guest OS, and the process for setting the second memory protection table that defines the memory area accessible by the second program executed by the CPU is a process:

for setting multiple second memory protection tables according to the guest application, and containing subsets for each virtual machine state corresponding to the second memory protection table, and

the process for switching the first memory protection table or the second memory protection table further includes:

a process for comparing the current state of the virtual machine, with the subset for the virtual machine state, and acquiring the position on the second memory protection table if the two states are a match.

In a program for a virtual machine according to the application concerned, the multiple guest applications are executed on the guest OS, and the procedure for setting the second memory protection table that defines the memory area accessible by the second program executed by the CPU is a sequence:

for setting multiple second memory protection tables according to the guest application, and containing subsets for each virtual machine state corresponding to the second memory protection table, and

the procedure for switching the first memory protection table or the second memory protection table further includes:

a procedure for comparing the current state of the virtual machine, with the subset for the virtual machine state, and acquiring the position on the second memory protection table if the two states are a match.

In a control method for a virtual machine according to the application concerned, the first or second memory protection tables are comprised of multiple tables, each table entry contains position information on other tables, and the process for switching to the first memory protection table or the second memory protection table includes a process for rewriting the pointer information onto another table.

In a program for a virtual machine according to the application concerned, the first or second memory protection tables are comprised of multiple tables, each table entry contains position information on other tables, and the procedure for switching to the first memory protection table or the second memory protection table, and the procedure for switching to the first memory protection table or the second memory protection table includes a procedure for rewriting the pointer information onto another table.

In a control method for a virtual machine according to the application concerned, the process for switching to the first memory protection table or the second memory protection table includes a process for updating the contents of the first or the second memory protection table.

In a program for a virtual machine according to the application concerned, the procedure for switching to the first memory protection table or the second memory protection table includes a procedure for updating the contents of the first or the second memory protection table.

In a control method for a virtual machine according to the application concerned, when the first or the second program has terminated, the control method includes a process for discarding the first or the second memory protection table corresponding to the terminated program.

In a program for a virtual machine according to the application concerned, when the first or the second program has terminated, the program includes a procedure for discarding the first or the second memory protection table corresponding to the terminated program.

A virtual machine system according to the application concerned includes a memory management unit for protecting the memory area with at least a two-stage privilege level.

A virtual machine system according to the application concerned includes a memory management unit for protecting the memory area with at least a two-stage privilege level.

This invention as described above can be used on virtual machine systems including a CPU containing virtual machine technology and CPUs expanded to 64 bits from pre-existing 32 bit architecture.

The foregoing invention has been described in terms of preferred embodiments. However, those skilled, in the art will recognize that many variations of such embodiments exist. Such variations are intended to be within the scope of the present invention and the appended claims.

What is claimed is:

1. A control method for a virtual machine provided by switching and executing multiple programs jointly shared between at least one CPU and memory, the method comprising:
a process for setting a first memory protection table for defining a memory area accessible by a first program executed on the CPU,
a process for setting a second memory protection table for defining a memory area accessible by a second program executed on the CPU,
a process for detecting the start of execution of the first or the second program,
a process for selecting and switching to either of a first or the second memory protection table according to the detected first or the second program, and
a process for checking the first or the second memory protection table with the memory management unit for the CPU, and protecting the memory area defined in the first or the second memory protection table.

2. The method according to claim 1, wherein
the first program is a virtual machine monitor for monitoring the virtual machine,
the second program is a guest program operating on the virtual machine, and
the virtual machine monitor itself performs the detection and switching.

3. The method according to claim 1, wherein
the first program is a guest OS operating on the virtual machine,
the second program is a guest application operating on the virtual machine, and
the virtual machine monitor managing the virtual machine performs the detection and the switching.

4. The method according to claim 2, wherein
the CPU contains a device for switching the guest program operated on the virtual machine, and a virtual machine monitor for managing the virtual machine, and
the process for detecting the start of the first or the second program execution detects the start of either the first or the second program execution when a command for switching control of the virtual machine was detected from the virtual machine monitor or the guest program.

5. The method according to claim 1, wherein
the CPU contains a register for showing the position in the memory on the first or the second memory protection table, and
the procedure for protecting the memory area sets the position of the selected first or the second memory protection table in the register.

6. A program of instructions executable by a physical computer to perform a function for providing virtual machine by switching multiple programs jointly using at least one CPU and memory on the physical computer, the function comprising:
a procedure for setting a first memory protection table for defining a memory area accessible by a first program executed by the CPU,
a procedure for setting a second memory protection table for defining a memory area accessible by a second program executed by the CPU,
a procedure for detecting the start of the first or the second program execution,
a procedure for selecting and switching either the first or the second memory protection table according the detected first or the second program, and
a procedure for checking the selected first or the second memory protection table in the memory management unit of the CPU, and protecting the memory area defined in the selected first or the second memory protection table.

7. The program according to claim 6, wherein
the first program is a virtual machine monitor that manages the virtual machine, and
the second program is a guest program that operates on the virtual machine.

8. The program according to claim 6, wherein
a first program is a guest OS operating on the virtual machine, and
the second program is a guest application operating on the virtual machine.

9. The program according to claim 7, wherein:
the CPU includes a device for switching the guest program operating on the virtual machine, and a virtual machine monitor for managing the virtual machine; and
the procedure for detecting the start of the first or the second program execution detects the start of either the first or the second program execution when a command was detected from the virtual machine monitor or the guest program for switching control of the virtual machine.

10. The program according to claim 6, wherein:
the CPU contains a register for showing the position in the memory on the first or the second memory protection table;
the procedure for protecting the memory area sets the position of a selected first or the second memory protection table in the register.

11. A virtual machine system including a virtual machine monitor to provide a virtual machine, by switching multiple programs jointly using at least one CPU and memory on a physical computer containing a CPU and memory, the system comprising:
the virtual machine that contains a first program, and a second program;
the virtual machine monitor that includes:
a memory protection table setting unit for setting a first memory protection table for defining the memory area accessible by a virtual machine monitor and a memory area accessible by a first program forming the virtual machine and, a second memory protection table for defining the memory area accessible by the virtual machine monitor and a memory area accessible by a second program,
an execution start detector unit for detecting the start of the first or the second program execution, and
a memory protection table switching unit for selecting and switching either of the first or the second memory protection tables corresponding to the detected first or the second program, and
a memory protection command unit for commanding the selected first or the second memory protection table in the CPU; and
the CPU that includes a memory management unit for protecting the memory area defined in the commanded first or the second memory protection tables.

12. A virtual machine system including a virtual machine monitor to provide a virtual machine, by switching multiple programs jointly using at least one CPU and memory on a physical computer containing a CPU and memory, comprising:
the virtual machine that contains a guest program;
the virtual machine monitor that includes:
a memory protection table setting unit for setting a first memory protection table for defining the memory area accessible by a guest program, and a second memory protection table for defining a memory area accessible by the virtual machine monitor,
an execution start detector unit for detecting the start of the guest program or the virtual machine monitor execution,
a memory protection table switching unit for selecting and switching either of the first or the second memory protection tables corresponding to the detected guest program or the virtual machine monitor, and
a memory protection command unit for commanding the selected first or the second memory protection table in the CPU; and
CPU that includes
a memory management unit for protecting the memory area defined in the commanded first or the second memory protection tables, and
a switching device for switching the guest program operating on the virtual machine and the virtual machine monitor, based on the start or the termination of the guest program execution.
